(19) United States
(12) Patent Application Publication
(10) Pub. No.: US 2026/0001718 A1
(43) Pub. Date: Jan. 1, 2026

(54) RESERVOIR AND METHOD FOR OPERATING THE RESERVOIR

(71) Applicant: G.D S.P.A., Bologna (IT) (IT)

(72) Inventors: Valerio AMORATI, Bologna (BO) (IT); Manuele CUCCHI, Bologna (BO) (IT); Giampaolo GIANESE; Mirco LEGNANI; Luca TESTONI

(21) Appl. No.: 18/880,718

(22) PCT Filed: Jul. 18, 2023
(86) PCT No.: PCT/IB2023/057306

§ 371 Date: Jan. 2, 2025

(30) Foreign Application Priority Data
Jul. 25, 2022 (IT) 102022000015573

(51) Int. Cl. B65G 1/04

(52) U.S. Cl. CPC B65G 1/045

(57) ABSTRACT

A reservoir comprises: at least one feed station equipped with a feed transfer device and associated or associable with at least one respective feed line for feeding articles; at least one pickup station equipped with a pickup transfer device and associated or associable with at least one respective removal line for removing articles; a movable support provided with a plurality of receiving seats for receiving articles and configured to move the receiving seats along a closed path passing through the feed station and the pickup station so that the articles are fed to the movable support by the feed transfer device and the articles are removed from the movable support by the pickup transfer device. The movable support comprises a plurality of sectors, each defining a plurality of receiving seats and movable independently of each other along the closed path.

### TECHNICAL FIELD

This invention relates to a reservoir and to a method for operating the reservoir.

The invention addresses the sector of industrial processes for the production, processing and packaging of articles in general. The type of articles, therefore, is not a limiting factor in the context of this invention. Whatever the case, by “article” is meant, preferably, a single object which can be gripped, transported and released individually. By way of a non-exhaustive example, the following may be considered articles according to this invention: food or confectionery products; components or sub-units of electronic cigarettes; electronic components; small mechanical parts.

### BACKGROUND ART

Known in the prior art are product reservoirs, multi-level in some cases, provided with input and output transfer devices. These, however, have complex structures which require stringent FIFO (first in first out) or LIFO (last in first out) programs.

In particular, tower solutions are known, where the products are stored on different levels and taken in or out by suitable transfer devices which must constantly move in three dimensions, vertically to reach the necessary level and horizontally in a plane at the level reached.

Also known are moving belt reservoirs, for example, in the cigarette sector, for temporarily storing a mass of cigarettes of variable volume along a helical path. This solution, which may involve both LIFO and FIFO systems, requires large, complex structures and, potentially, even long-term product storage and the impossibility of selecting specific quantities of the product to be withdrawn.

### DISCLOSURE OF THE INVENTION

The Applicant has noticed that these solutions can be improved in terms of efficiency, that is to say, in terms of their ability to absorb variations between the flow of incoming articles and the flow of outgoing products. In effect, in the prior solutions, variations between input and output flows lead to zones where the products are more closely packed and zones where there are fewer products, negatively impacting pick and place operations and reducing storage efficiency.

In this context, the basic technical purpose of this invention is to provide a reservoir and a method for operating the reservoir to overcome the above mentioned disadvantages of the prior art.

In particular, the aim of this invention is to provide a reservoir and a method for operating the reservoir which can improve efficiency compared to the prior art.

The technical purpose indicated and the aim specified are substantially achieved by a reservoir and a method for operating the reservoir comprising the technical features set out in claims 1 and 9 and/or in one or more of the claims dependent thereon.

### BRIEF DESCRIPTION OF THE DRAWINGS

Further features and advantages of the invention are more apparent in the non-limiting description which follows of a preferred but non-exclusive embodiment of a reservoir and a method for operating the reservoir, as illustrated in the accompanying drawings, in which:

FIG. 1 is a simplified perspective view of a reservoir according to a first embodiment of this invention;

FIGS. 2A-2F schematically represent a succession of operating steps for using the reservoir of FIG. 1;

FIG. 3 is a simplified perspective view of a reservoir according to a second embodiment of this invention;

FIGS. 4A-4H schematically represent a succession of operating steps for using the reservoir of FIG. 3.

### DETAILED DESCRIPTION OF PREFERRED EMBODIMENTS OF THE INVENTION

The numeral 1 in the accompanying drawings denotes in its entirety a reservoir according to this invention, suitable for the temporary storage of articles.

In the context of this invention, the term “articles” is used to denote products of diverse kinds such as, by way of non-limiting example: food or confectionery products; components or sub-units of electronic cigarettes; electronic components; small mechanical parts.

Regardless of the type of product, the reservoir 1 is suitable for working between a production line upstream and a processing or packaging line downstream, to hold or deliver articles when the capacities of the lines upstream and downstream are imbalanced.

Moreover, the reservoir 1 is of a mobile type, that is to say, normally mobile in such a way as to move the articles and the respective housings cyclically, in particular with continuous and/or uniform motion.

In its more general aspects, as shown in the accompanying drawings, the reservoir 1 comprises one or more feed stations 2, each associated or associable with at least one respective feed line 2a for feeding articles and equipped with a respective feed transfer device 2b, and one or more pickup stations 3, each associated or associable with at least one respective removal line 3 for removing articles and equipped with a respective pickup transfer device 3b.

The reservoir 1 also comprises a movable support 4 provided with a plurality of receiving seats 5 for receiving single articles (not illustrated) and configured to move the receiving seats 5 along a closed path passing through the feed station 2 and the pickup station 3 so that the articles are fed to the movable support 4 by the feed transfer device (or devices) 2b and the articles are removed from the movable support 4 by the pickup transfer device (or devices) 3b.

In other words, the feed transfer device 2b transfers the articles from the feed line 2a to the receiving seats 5 of the movable support 4, and the pickup transfer device 3b transfers the articles from the receiving seats 5 of the movable support 4 to the removal line 3a. The reservoir 1 is preferably configured to move individual articles towards and away from the movable support 4; in other words, the transfer devices 2b, 3b are configured to pick up, transfer and release one single article at a time. Alternatively, the transfer devices 2b, 3b may be configured to pick up, transfer and release a group of articles at a time.

The transfer devices 2b, 3b illustrated are in the form of articulated arms; they may, however, be embodied in any form, for example, Cartesian actuators, anthropomorphic robots and so on.

Preferably, the receiving seats 5 are distributed on the movable support 5 according to a two-dimensional distribution, in particular, in a plurality of longitudinal rows (circles) running alongside each other.

The movable support 4 is made preferably in a circular or annular configuration, in particular with rotational motion of the receiving seats 5 about a vertical axis X, in particular continuous motion (at a constant speed) along the closed path.

According to the invention, the movable support 4 comprises a plurality of sectors 4a, 4b, 4c, 4d, each defining a plurality of receiving seats 5 and movable independently of each other along the closed path. There may be any number of sectors, preferably two, three, four or more than four. In the embodiments illustrated, there are four such sectors.

The sectors 4a, 4b, 4c, 4d define respective planar supporting surfaces, provided with receiving seats 5, and coplanar with each other. The supporting surfaces cooperate to define a single, substantially uninterrupted supporting surface of the movable support 4.

The sectors 4a, 4b, 4c, 4d each comprise a respective independent motor (not illustrated) to move the respective sector 4a, 4b, 4c, 4d along the closed path. The motor may be housed in a supporting base of the sectors 4a, 4b, 4c, 4d and may comprise, for example, rack and pinion means or linear motors.

The reservoir 1 also comprises a control unit (not illustrated) connected to the motors and to the pickup transfer device 2b and the release transfer device 3b to set one or more predetermined logics of driving the motors and the transfer devices 2b, 3b, as set out below. In particular, the control unit is configured to move one or more of the sectors 4a, 4b, 4c, 4d independently of each other and/or relative to the other sectors 4a, 4b, 4c, 4d. Thus, two or more sectors 4a, 4b, 4c, 4d can be moved simultaneously and independently of each other as a function of the respective filled/empty conditions.

According to an aspect of the invention, transferring the articles from the feed line 2a to the receiving seats 5 is carried out by transferring the articles to the receiving seats 5 of the same sector 4a, 4b, 4c, 4d until reaching a predetermined filling level of the sector 4a, 4b, 4c, 4d and, only after reaching the predetermined filling level of that sector 4a, 4b, 4c, 4d, transferring further articles to a different sector 4a, 4b, 4c, 4d, in particular, an adjacent sector 4a, 4b, 4c, 4d.

Similarly, transferring the articles from the receiving seats 5 of one sector 4a, 4b, 4c, 4d to the removal line 3a is carried out by picking up the articles from the receiving seats 5 of the same sector 4a, 4b, 4c, 4d until reaching a predetermined empty level of the sector 4a, 4b, 4c, 4d (in particular, until the sector 4a, 4b, 4c, 4d is completely empty) and, only after reaching the predetermined empty level, picking up further articles from a different sector 4a, 4b, 4c, 4d, in particular, an adjacent sector 4a, 4b, 4c, 4d.

Preferably, the filling and emptying of each sector 4a, 4b, 4c, 4d is carried out progressively by progressively advancing the sector 4a, 4b, 4c, 4d through the respective feed station 2 or pickup station 3, without leaving empty seats. After passing through, the sector 4a, 4b, 4c, 4d is completely full (or in any case, full in the respective stretch of it concerned) without leaving empty seats, hence during a single passage of the sector 4a, 4b, 4c, 4d through the respective feed station 2 or pickup station 3.

Moreover, transferring the articles from the receiving seats 5 of the sector 4a, 4b, 4c, 4d to the removal line 3a is carried out only when that sector 4a, 4b, 4c, 4d has been previously filled to the predetermined filled level. Before such filling, the sector 4a, 4b, 4c, 4d is considered as having an incomplete filled level, and the action of removing the articles from that sector 4a, 4b, 4c, 4d by the pickup transfer device 3b is thus disabled (by the control unit).

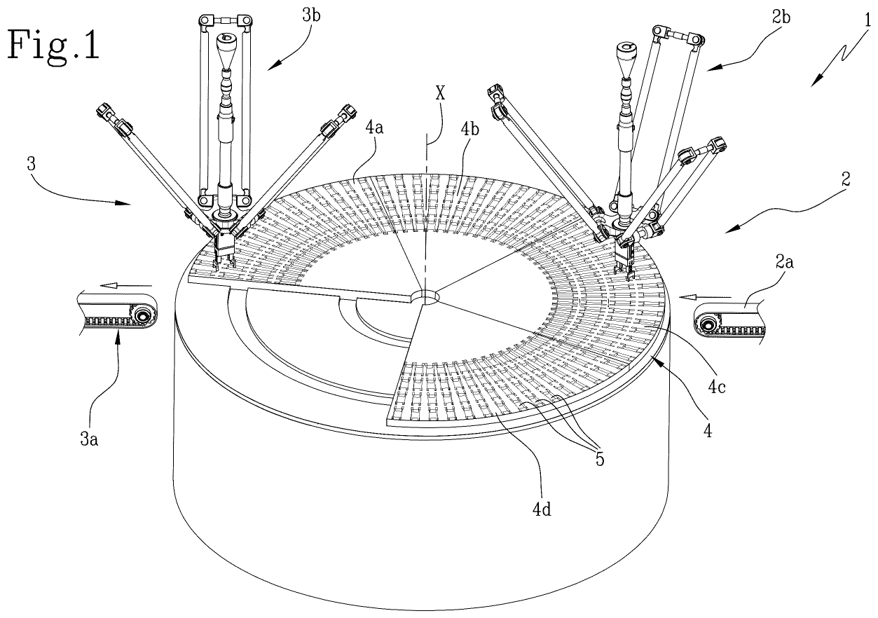

FIG. 1 shows a first embodiment of the reservoir 1 according to the invention. In this embodiment, the sectors 4a, 4b, 4c, 4d are angular sectors, each having an angular size of 60°, so as to cover a total angle of 240°. More generally speaking, regardless of their number, the angular sectors define a total angle of less than 360° and, in particular, between 180° and 300°. Furthermore, the angular sectors 4a, 4b, 4c, 4d preferably have the same angular size and, more preferably, are identical.

Preferably, also, on each angular sector 4a, 4b, 4c, 4d, the receiving seats 5 are distributed according to a two-dimensional distribution, preferably in such a way that the receiving seats of all the angular sectors 4a, 4b, 4c, 4d are distributed according to concentric circular rows.

In this embodiment, the feed station 2 and the pickup station 3 are angularly spaced by an angle of between 90° and 270°, preferably between 120° and 240°, and more preferably, equal to 180°. This angle is defined as the angle of the operating stretch of the closed path followed by the receiving seats 5 from the feed station 2 to the pickup station 3.

In this embodiment, also, the aforementioned predetermined filled level of the sector 4a, 4b, 4c, 4d corresponds preferably to the complete filling of the sector itself.

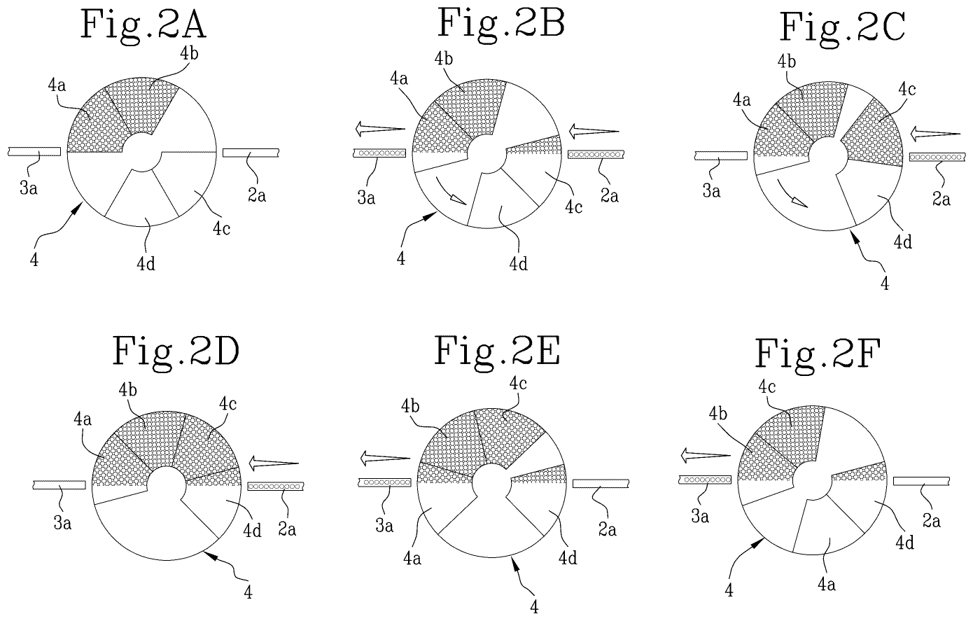

FIGS. 2A-2F represent a sequence of operating steps for using the reservoir according to FIG. 1. According to this sequence, which constitutes only one operating example of all the numerous possible situations, the movable support 4 starts from a situation where it is partially filled, in particular only the first and the second angular sector 4a, 4b being completely full and the other two angular sectors 4c, 4d being empty (FIG. 2A). Activating the feed line 2a and the removal line 3a simultaneously causes the first angular sector 4a to be progressively emptied by the pickup transfer device 3b and the third angular sector 4c to be progressively filled by the feed transfer device 2b (FIG. 2B). If the removal line 3a is interrupted, the first two angular sectors 4a, 4b remain stationary, while the other two angular sectors 4c, 4b continue advancing along the closed path and are progressively filled by the feed transfer device 2b (FIG. 2C).

Filling may proceed until the third sector 4c comes into contact with the second sector 4b, which is stationary, creating a stop condition (FIG. 2D). When the removal line 3a resumes its operating configuration, the angular sectors (now packed against each other) can once again be advanced and progressively emptied. When the first angular sector 4a is completely empty, it is separated from the other sectors 4b, 4c, 4d and moved to the feed station 2, where a new filling cycle is started (FIG. 2E) and, at the same time, the second angular sector 4b is progressively emptied (FIG. 2F).

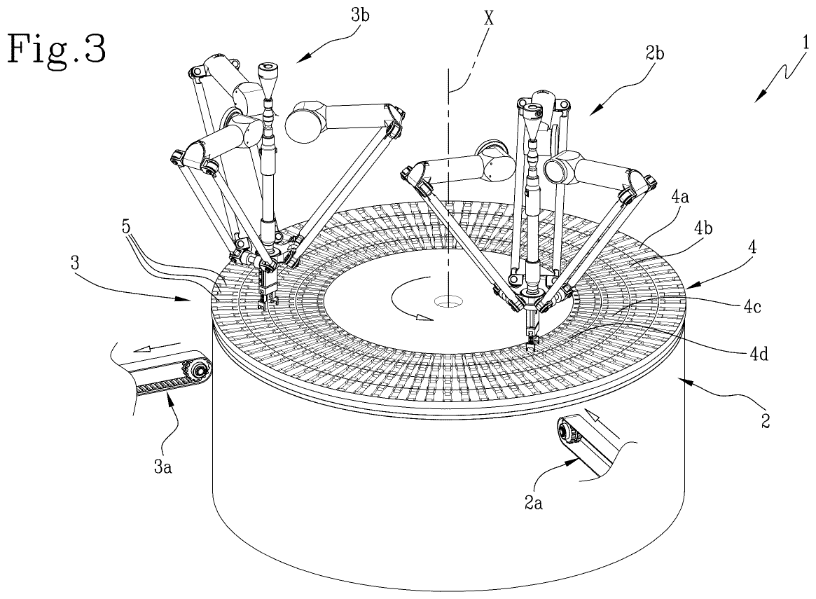

FIG. 3 shows a second embodiment of the reservoir 1 according to the invention. In this embodiment, the sectors 4a, 4b, 4c, 4d are circular sectors having a preferably closed (annular) shape and being coaxial with each other. The circular sectors 4a, 4b, 4c, 4d are radially nested into each other so as to be disposed in sequence along a radial direction towards the axis X.

Preferably, in this case too, the receiving seats 5 are distributed on each circular sector 4a, 4b, 4c, 4d according to a two-dimensional distribution over the entire circumferential extension of the sectors 4a, 4b, 4c, 4d or over a part thereof.

In this embodiment, the feed station 2 and the pickup station 3 are angularly spaced by an angle of between 45° and 180°, preferably equal to approximately 90°, so as to maximize the size of the operating transporting stretch from the feed station 2 to the pickup station 3.

In this embodiment, also, the aforementioned predetermined filled level of the sector 4a, 4b, 4c, 4d corresponds to completely filling the predetermined angular stretch of the sector 4a, 4b, 4c, 4d included between the feed station 2 and the pickup station 3. Alternatively, the predetermined filled level may be considered as the sector 4a, 4b, 4c, 4d being completely full.

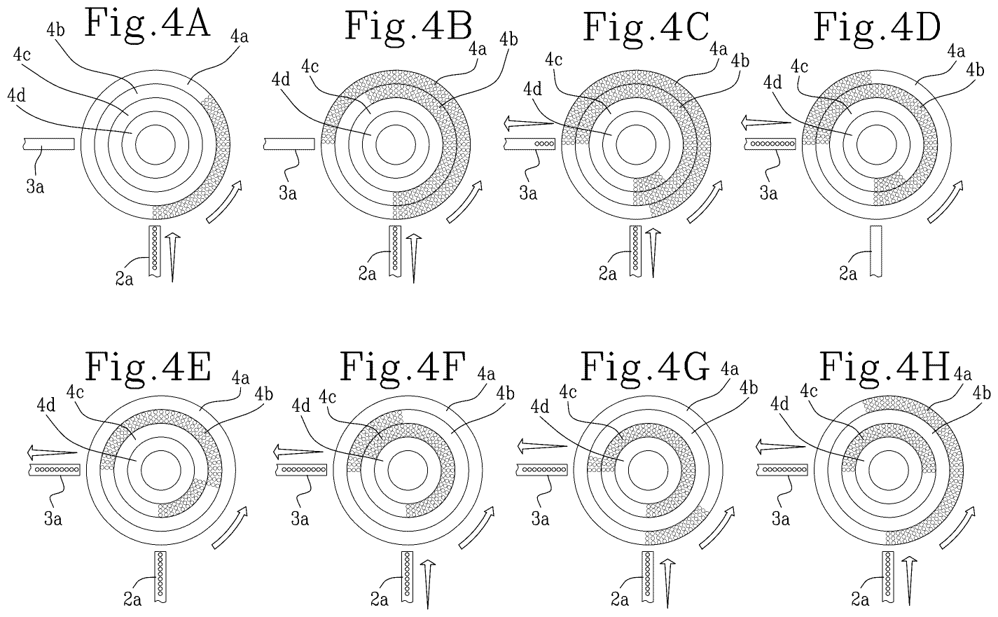

FIGS. 4A-4H represent a sequence of operating steps for using the reservoir 1 according to FIG. 3. In this sequence, which constitutes only one operating example of all the numerous possible situations, starting from a situation where the first circular sector 4a (for example, the outermost one) of the movable support 4 is partially full (FIG. 4A), the first sector 4a is progressively filled by rotating the first sector 4a about the axis X until completely filling at least the operating stretch of the first sector 4a included between the feed station 2 and the pickup station 3. When filled in this way, the first sector 4a is stopped and the second sector 4b, preferably adjacent to it, starts filling (FIG. 4B). When the first circular sector 4a is completely full to the predetermined level, the removal line 3a is activated and, at the same time, the pickup transfer device 3b is activated, starting to fill the second circular sector 4b at the same time, and when necessary, starting to fill the third sector 4c (when the second sector 4b is complete), and progressively emptying the first circular sector 4a (FIG. 4C).

If the feed line 2a stops, the pickup transfer device 3b nevertheless continues to empty the first sector 4a (FIG. 4D) and, when this is completely empty, starts emptying the second sector 4b (FIG. 4E). Preferably, the chronological order of emptying coincides with the chronological order of filling.

When the feed line 2a is reactivated (FIG. 4F), the third sector 4c continues to be filled and the second sector 4b emptied. Preferably, when filling or emptying a sector is resumed after being interrupted, that same sector continues to be filled or emptied, respectively, before starting on a different sector.

Next, when the third sector 4c is completely full, the first sector 4a starts filling (FIG. 4G) and when the second sector 4b is completely empty, the third sector 4c starts emptying (FIG. 4H).

Preferably, the different circular sector to be filled or emptied is selected following a precise radial order, for example, always from the outside to the inside or vice versa. For example, in the situation of FIGS. 4A-4H, where emptying or filling is always carried out on the radially outermost sector towards the innermost one, the third sector 4c, at the position shown in FIG. 4G, has just reached its predetermined filled condition, and this is followed by emptying starting from the first free, outermost circular sector, hence from the first sector 4a and not from the fourth 4d.

To carry out this drive logic, the reservoir 1 preferably comprises detecting means (not illustrated) for detecting a filled condition of at least some of the receiving seats 5. In particular, the detecting means can detect a filled condition only of the receiving seats 5 of the angular or circular sector currently being processed (emptying/filling) or a filled condition of all the receiving seats 5 of the movable support 4.

Preferably, the detecting means are configured to detect the filled condition at predetermined time intervals, in particular, at time intervals preferably shorter than the time that elapses between the passage of one receiving seat 5 and the next receiving seat 5. More preferably, detection occurs at a frequency greater than or equal to 5 Hz, which, in the context of this use, corresponds to continuous or “quasi-continuous” detection.

In a preferred embodiment, the detecting means comprise one or more cameras, for example, located above the movable support 4.

In an alternative solution, the detecting means are presence sensors inside each receiving seat 5 and configured to generate an article present and/or absent signal at the aforesaid predetermined frequency or to detect an absent/present variation condition and vice versa.

The detecting means thus generate respective (optical and/or electrical) signals identifying the filled condition of at least some of the receiving seats 5 of the movable support 4.

The reservoir 1 also comprises a control unit (not illustrated) connected to the transfer devices 2b, 3b and configured to drive the transfer devices 2b, 3b and the angular/circular sectors 4a, 4b, 4c, 4d as a function of the state (operational/interrupted) of the feed and removal lines 2a, 3a and as a function of the state (filled/empty/partly filled) of the sectors 4a, 4b, 4c, 4d. In particular, the control unit is configured to drive each transfer device 2b, 3b independently of the others and preferably at a constant transfer speed or frequency.

This invention achieves the preset aim, overcoming the disadvantages of the prior art.

Indeed, the fact that the movable support 4 is made up of independent sectors 4a, 4b, 4c, 4d means that the steps of filling and emptying can be carried out (and preferably must be carried out) on distinct sectors, so that any variations or interruptions in the flow of the feed line do not impact the step of picking up, and vice versa. This results in optimum storage efficiency, capable of compensating even significant imbalances between input and output flows.

1. A reservoir, comprising:
at least one feed station equipped with a feed transfer device and associated or associable with at least one respective feed line for feeding articles;
at least one pickup station equipped with a pickup transfer device and associated or associable with at least one respective removal line for removing articles;
a movable support provided with a plurality of receiving seats for receiving articles, preferably single articles, and configured to move the receiving seats along a closed path passing through the feed station and the pickup station so that the articles are fed to the movable support by the feed transfer device and the articles are removed from the movable support by the pickup transfer device;
wherein the movable support comprises a plurality of sectors, each defining a plurality of receiving seats and movable independently of each other along the closed path.

2. The reservoir according to claim 1, wherein the movable support is circular in shape and wherein the sectors are disposed in succession along a radial direction.

3. The reservoir according to claim 2, wherein the sectors are annular in shape and concentric.

4. The reservoir according to claim 1, wherein the movable support has a circular shape and wherein the sectors have an angular shape and are distributed in succession along a circular path.

5. The reservoir according to claim 1, wherein the sectors define respective supporting surfaces, provided with the receiving seats, and are coplanar with each other.

6. The reservoir according to any claim 1, wherein the sectors are each provided with a two-dimensional distribution of receiving seats.

7. The reservoir according to claim 1, comprising a plurality of independent motors, each associated with a respective sector of the movable support.

8. The reservoir according to claim 1. further comprising a control unit connected to the motors and to the feed transfer device and pickup transfer device to set one or more predetermined logics of driving the motors and the transfer devices.

9. A method for operating a reservoir, in particular a reservoir according to claim 1, wherein the reservoir comprises: at least one feed station equipped with a feed transfer device and associated with at least one respective feed line for feeding articles; at least one pickup station equipped with a pickup transfer device and associated with at least one respective removal line for removing articles; and a movable support provided with a plurality of receiving seats for receiving articles, preferably single articles, and configured to move the receiving seats along a closed path passing through the feed station and the pickup station so that the articles are fed to the movable support by the feed transfer device and the articles are removed from the movable support by the pickup transfer device;
the method comprising the steps of transferring a plurality of articles from the feed line to the receiving seats of the movable support, moving the articles by means of the receiving seats of the movable support from the feed station to the pickup station, and transferring a plurality of articles from the receiving seats of the movable support to the removal line;
wherein the movable support comprises a plurality of sectors, each defining a plurality of receiving seats and movable independently of each other along the closed path and wherein the step of moving the articles by means of the movable support is carried out by moving one or more sectors of the movable support independently of each other and/or relative to the other sectors.

10. The method according to claim 9, wherein the step of transferring the plurality of articles from the feed station to the receiving seats is carried out by transferring the articles to the receiving seats of the same sector until reaching a predetermined filling level of the sector and, only after reaching the predetermined filling level of that sector, transferring further articles to a different sector, in particular, an adjacent sector.

11. The method according to claim 10, wherein the movable support is circular in shape and wherein the sectors are disposed in succession along a radial direction, and wherein the predetermined filling level corresponds to completely filling a predetermined angular stretch of the sector included between the feed station and the pickup station.

12. The method according to claim 10, wherein the movable support is circular in shape, the sectors are angular in shape and distributed in succession along a circular path, and wherein the predetermined filling level corresponds to completely filling the sector.

13. The method according to claim 10, wherein the step of transferring the plurality of articles from the receiving seats of the movable support to the removal line is carried out by starting to pick up the articles from a sector only after reaching the predetermined filling level of that sector.

14. The method according to claim 9, wherein the step of transferring the plurality of articles from the receiving seats of the movable support to the removal line is carried out by picking up the articles from the receiving seats of the same sector until reaching a predetermined emptying level of the sector and, only after reaching that predetermined emptying level, picking up further articles from a different sector, in particular, an adjacent sector.
